(19) United States
(12) Patent Application Publication
(10) Pub. No.: US 2017/0197785 A1
(43) Pub. Date: Jul. 13, 2017

(54) BLOW MOLDED WASTE CART WITH MOLDED AXEL RETAINING STRAPS

(71) Applicants: Bruce Hamilton, Jefferson, OH (US); Brian Moroney, Mentor, OH (US); Douglas Eck, Wichita, KS (US)

(72) Inventors: Bruce Hamilton, Jefferson, OH (US); Brian Moroney, Mentor, OH (US); Douglas Eck, Wichita, KS (US)

(73) Assignee: Toledo Molding & Die, Inc., Toledo, OH (US)

(21) Appl. No.: 15/172,431

(22) Filed: Jun. 3, 2016

Related U.S. Application Data
(60) Provisional application No. 62/170,531, filed on Jun. 3, 2015.

(51) Int. Cl. B65F 1/14; B65F 1/02; B29C 49/48; B62B 1/24

(52) U.S. Cl. CPC B65F 1/1473; B62B 1/24; B65F 1/02; B29C 49/4802; B62B 2501/065; B62B 2202/20; B65F 2250/114; B29L 2031/712

(57) ABSTRACT

A body for a blow-molded waste cart and a waste cart having a blow-molded hollow body having a rear wall, a floor, the body and floor form a waste receptacle and a pair of axle straps integrally formed with the body. The axle straps each include a penetration with a strap bearing surface formed in penetration of the axle strap. The cart body may also include a longitudinal bearing surface with the strap bearing surface being aligned with the longitudinal bearing surface. The strap bearing surface is preferably cylindrical. A waste cart may be formed by adding an axle mounted to the body by the axle straps and wheels mounted to either end of the axle. A method of forming the carte body is also disclosed in which a pair of opposed pins are slid into the axle straps to form the axle strap bearing surfaces.

### TECHNICAL FIELD AND INDUSTRIAL APPLICABILITY OF THE INVENTION

The present invention relates to blow molded waste carts, also referred to as wheeled trashcans, which are substantially constructed of blow-molded polymeric materials. The present invention related specifically to a blow-molded axle-retaining device. The axle retaining straps provide a strong and resilient mechanism for mounting the axle to the waste cart without the use of mechanical fasteners or adhesives. A blow molded waste cart that is assembled without the use of mechanical fasteners or adhesives provides a sturdier cart with reduced assembly cost and improved durability.

### BACKGROUND OF THE INVENTION

Blow molding is used to produce generally hollow plastic parts by melting plastic infeed material, forming a parison (a tubular piece of plastic), placing the parison into a mold and blowing air into the parison to force the plastic out to match the mold. The plastic cools and hardens within the mold and the mold is opened and the part is ejected. The main bodies of waste carts have been made by the blow molding process for many years; however, previous blow-molded waste carts required a substantial number of additional mechanically attached parts. Alternatively, a separate hole must be drilled or a snap fit fixture is used that may come apart under stress. The use of mechanical attachments or snap fit connections increases the cost of manufacture while increasing the number of potential failure points while in use.

### SUMMARY OF THE INVENTION

The present invention relates to blow-molded waste carts and more specifically to waste carts with to a blow-molded axle-retaining device. The axle retaining straps disclosed provide a strong and resilient mechanism for mounting the axle to the waste cart without the use of mechanical fasteners, snap fit attachments or adhesives. Specifically, a body for a blow-molded waste cart and a waste cart is disclosed having a blow-molded hollow body with a rear wall and a handle keyway formed in the rear wall

### BRIEF DESCRIPTION OF THE DRAWING

A more complete appreciation of the invention and the many embodiments thereof will be readily obtained as the same becomes better understood by reference to the following detailed description when considered in connection with the accompanying drawings, wherein:

FIG. 1A illustrates a side view of a blow-molded waste cart having axle retaining straps for mounting an axle to the waste cart in accordance with the present invention;

FIG. 1B illustrates a rear view of a blow-molded waste cart having axle retaining straps for mounting an axle to the waste cart in accordance with the present invention;

FIG. 1C illustrates a detailed side view of a blow-molded waste cart having axle retaining straps for mounting an axle to the waste cart in accordance with the present invention;

FIG. 2A illustrates a perspective view of a blow-molded waste cart having axle retaining straps for mounting an axle to the waste cart in accordance with the present invention; and

FIG. 2B illustrates a detailed perspective view of a blow-molded waste cart having axle retaining straps for mounting an axle to the waste cart in accordance with the present invention.

### DETAILED DESCRIPTION AND PREFERRED EMBODIMENTS OF THE INVENTION

The present invention will now be described with occasional reference to the specific embodiments of the invention. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise.

Unless otherwise indicated, all numbers expressing quantities of ingredients, properties such as molecular weight, reaction conditions, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements.

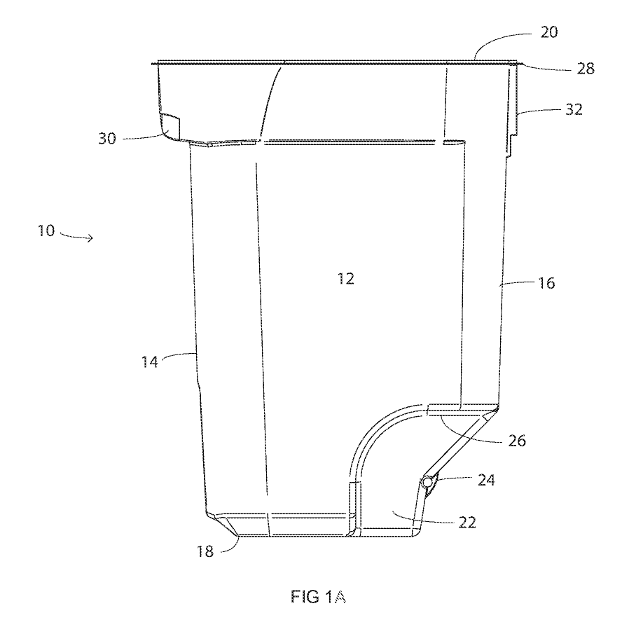

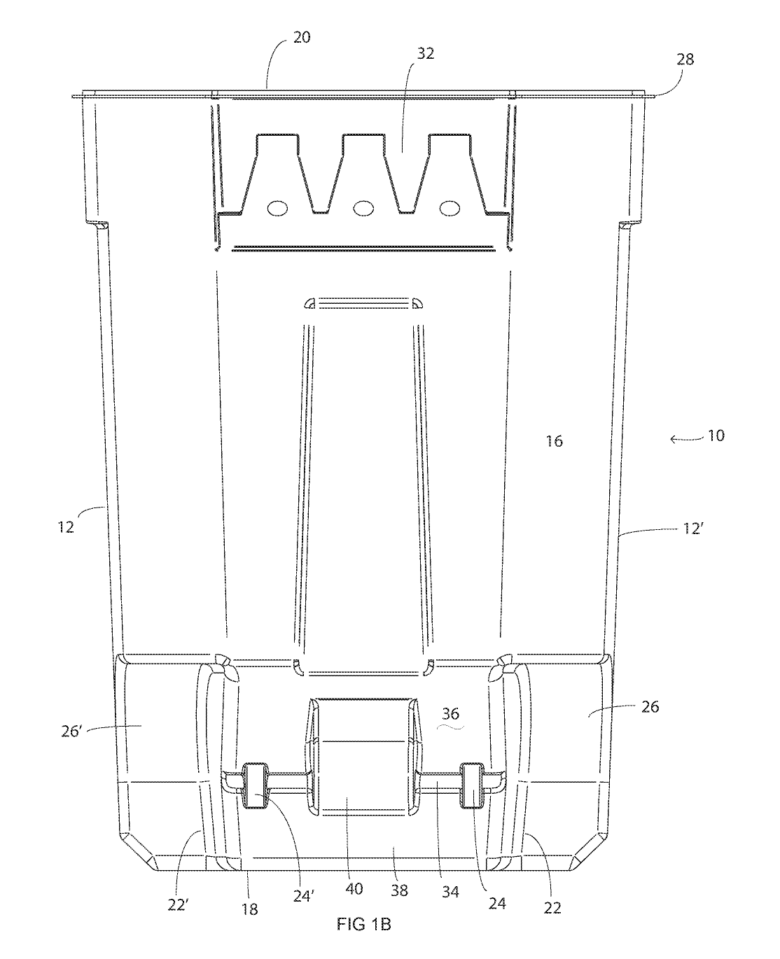

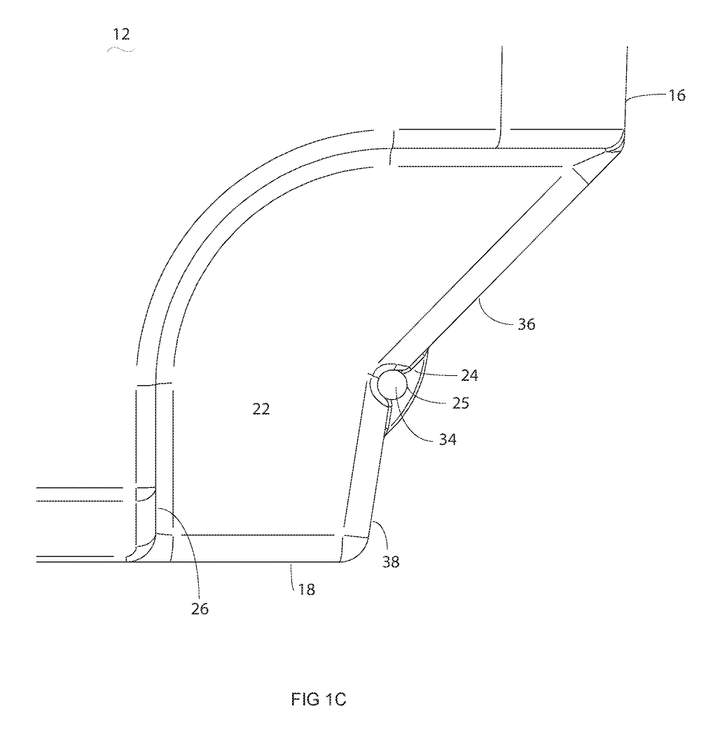

A blow molded waste cart is shown in FIG. 1. The cart 10 includes a hollow central body formed by front wall 14, rear wall 16, right wall 12, left wall 12′ and floor 18 such that waste may be received within the hollow central body. Cart body 10 includes cutouts 22 with fender sections 26 in sidewalls 12, 12′ for wheels (not shown) to be mounted on an axle retained by axle strap 24. Waste cart 10 may be tilted to roll on the wheels and returned to a vertical orientation to rest in a stable, vertical position. The top of waste cart 10 includes an upper rim 20 and may optionally include a reinforcing flange 28. Reinforced lift pocket 30 and handle insert 32 for a handle may also be included.

The blow-molded cart of the present invention, including axle retaining straps for mounting an axle to the waste cart in accordance with the present invention is shown in FIG. 1B. Cart 10 includes a hollow central body formed by front wall 14 (not shown) , rear wall 16, right wall 12, left wall 12′ with reinforcing flange 28 and floor 18 such that waste may be received within the hollow central body. Handle insert 32 for a handle may also be included. Cart body 10 includes cutouts 22, 22′ with fender sections 26, 26′ in sidewalls 12, 12′ for wheels (not shown) to be mounted on an axle retained by axle straps 24, 24′. Waste cart 10 may be tilted to roll on the wheels and returned to a vertical orientation to rest in a stable, vertical position. Rear wall 16 includes longitudinal bearing surface 34 and at least two axle-retaining straps 24, 24′. The straps are formed in the blow molding process by forming the arcuate section of strap 24. A cylindrical penetration through straps 24, 24′ are formed while waste cart body 10 is in the mold, by pressing opposed pins through the arcuate section. The pins meet and leave a thin web of polymer, which may be removed by forcing the axle through the web. Lower surface 36 is angled into the body of cart 10 with extending wall 38 extending downwardly to cart base 18. A kick surface 40 is formed in walls 36, 38 to assist a user in tipping the can back onto the wheels.

The blow-molded cart of the present invention is shown in greater detail in FIG. 1C. Cutout 22 and fender 26 are shown formed into left side 12 and rear wall 16 of cart 10. Lower surface 36 and extending wall 38 position the axle bearing surface 34 at a position where cart 10 may be balanced on the wheels (not shown). The arcuate section of axle straps 24, 24′ include strap bearing surfaces 25, 25′ on the interior faces such that an axle will rotate smoothly within the circumferential bearing surface formed by strap bearing surface 25 and axle bearing surface 34. Kick surface 40, having opposed sidewalls 41, is formed in walls 36, 38 to assist a user in tipping the can back onto the wheels.

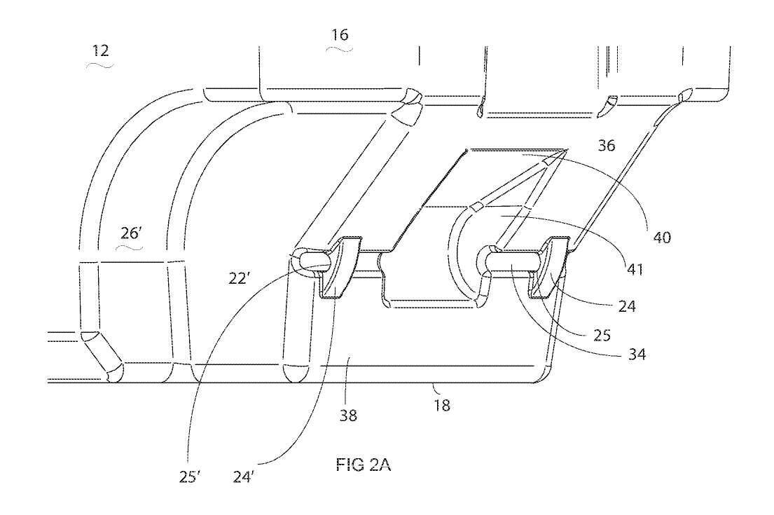

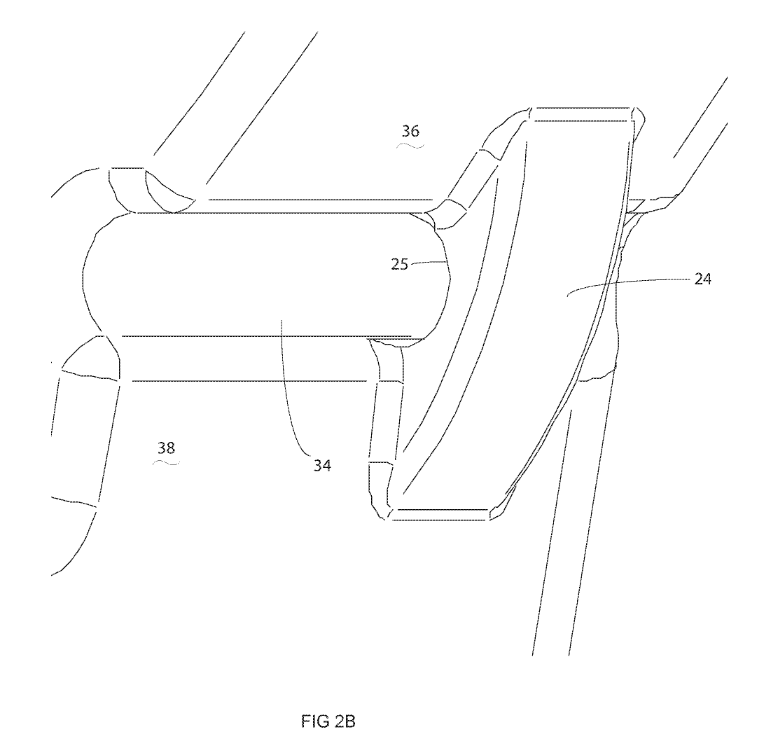

The axle straps are shown in a perspective view in FIG. 2B. The arcuate axle retaining straps 24, 24′are penetrated during the molding step by opposed pins that are inserted parallel to axle bearing surface 34, such that the penetrations align with the bearing surface 34. Cutout 22′ and fender 26′ are shown formed into left side 12 and rear wall 16. Lower surface 36 and extending wall 38 position the axle bearing surface 34 at a position where cart 10 may be balanced on the wheels (not shown). The arcuate section of straps 24, 24′ is formed in the blow-molding step and the cylindrical penetration through the strap is formed in the mold while the polymer is warm and pliable with opposed pins pressed through the arcuate sections to leave a thin web of polymer. The mold cylinder creates a strap bearing surfaces 25, 25′ on the interior face of straps 24, 24′ such that an axle will rotate smoothly within the circumferential bearing surface formed by strap bearing surface 25, 25′ and axle bearing surface 34. The width of bearing surfaces 24, 24′ may vary between about 2.4 cm and 25cm or more. The width is substantially wider than the thickness of the structural portions of the cart, which are generally less than 1 cm.

The axle straps are shown in a perspective view in FIG. 2B. The arcuate axle retaining straps 24, 24′ are penetrated during the molding step by opposed pins that are inserted parallel to axle bearing surface 34, such that the penetrations align with the bearing surface 34. Lower surface 36 and extending wall 38 position the axle bearing surface 34 at a position where cart 10 may be balanced on the wheels (not shown). The mold cylinder creates a strap bearing surfaces 25, 25′ on the interior face of straps 24, 24′ such that an axle will rotate smoothly within the circumferential bearing surface formed by strap bearing surface 25, 25′ and axle bearing surface 34. The width of bearing surfaces 24, 24′ may vary between about 2.4 cm and 25 cm or more. The width is substantially wider than the thickness of the structural portions of the cart which are generally less than 1 cm.

The waste cart is formed in a blow molding manufacturing process. The blow molding process begins melting the polymer material and forming a forming it into a parison. The parison is a polymer sleeve that is clamped into a mold. The mold includes two halves, which are generally referred to as the pin half and the bushing half. The pin half and bushing half are clamped around the parison. Air is then blown into the mold to force the parison against the mold to form the general shape of the can and axle straps. The mold includes a pair of opposed pins at each axle strap. After the waste cart body is formed, but while the polymer is warm and pliable in the mold, the pins slide into position to compress the polymer of the strap and form a strap bearing surface that is co-planar with the longitudinal bearing surface formed in the cart body. Once the waste cart is formed and the plastic has cooled somewhat the pins disengaged, the mold is opened and the waste cart is ejected.

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

We claim:

1. A blow-molded waste cart body, comprising:
a blow-molded hollow body having a rear wall;
a floor, the body and floor form a waste receptacle; and
a pair of axle straps integrally formed with the body.

2. The blow-molded waste cart of claim 1, further comprising:
a penetration through each axle strap.

3. The blow-molded waste cart of claim 2, further comprising:
a strap bearing surface formed in penetration of the axle strap.

4. The blow-molded waste cart of claim 3, further comprising:
a longitudinal bearing surface formed in the body.

5. The blow-molded waste cart of claim 4, wherein the strap bearing surface and the longitudinal bearing surface are aligned.

6. The blow-molded waste cart of claim 1, further comprising:
a cylindrical strap bearing surface formed in the axle strap.

7. The blow-molded waste cart of claim 1, further comprising:
an axle mounted to the body by the axle straps; and
wheels mounted to either end of the axle.

8. A blow-molded waste cart, comprising:
a blow-molded hollow body having a rear wall and a handle keyway formed in the rear wall;
a floor, the body and floor form a waste receptacle;
a pair of axle straps integrally formed with the body;
an axle mounted to the body by the axle straps; and
wheels mounted to either end of the axle.

9. The blow-molded waste cart of claim 8, further comprising:
a penetration through each axle strap.

10. The blow-molded waste cart of claim 9, further comprising:
a strap bearing surface formed in penetration of the axle strap.

11. The blow-molded waste cart of claim 10, further comprising:
a longitudinal bearing surface formed in the body.

12. The blow-molded waste cart of claim 11, wherein the strap bearing surface and the longitudinal bearing surface are aligned.

13. The blow-molded waste cart of claim 8, further comprising:
a cylindrical strap bearing surface formed in the axle strap.

14. The blow-molded waste cart of claim 8, further comprising:
in a post-processing step by opposed pins that are inserted parallel to the bearing surface, such that the penetrations align with the bearing surface.

15. A method of forming a blow-molded waste cart body comprising the steps of:
melting a polymer material;
forming the polymer material into a parison;
enclosing the parison in a mold, the mold having a pair of arcuate axle straps formed in the rear wall; and
sliding a pair of opposed pins into the axle straps to form an axle strap bearing surface.

16. The method of forming a waste cart body a blow molding process of claim 15, wherein and the axle bearing strap surface is cylindrical.

17. The method of forming a waste cart body a blow molding process of claim 16, wherein the axle bearing strap surface is aligned with an axle bearing surface formed in the rear wall.

18. The method of forming a waste cart body a blow molding process of claim 17, wherein axle bearing strap surface is formed in a post-blowing step by opposed pins inserted parallel to the bearing surface, such that the pins align with the bearing surface.
